(19) United States
(12) Patent Application Publication
(10) Pub. No.: US 2006/0129559 A1
(43) Pub. Date: Jun. 15, 2006

(54) Concurrent access to RAID data in shared storage

(75) Inventors: Ananda C. Sankaran, Austin, TX (US); Peyman Najafirad, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/012,586

(22) Filed: Dec. 15, 2004

(51) Int. Cl. G06F 17/30

(52) U.S. Cl. 707/10

(57) ABSTRACT

A system and method is disclosed for managing the serving of read and write commands in a computer cluster system having redundant storage. A plurality of database servers is included in the computer cluster network to serve read and write commands from the database clients of the network. One of the database servers is configured to handle both read commands and write commands. The remainder of the database servers are configured to handle only read commands. The database of the computer system includes a redundant storage subsystem that involves the use of mirrored disks associated with each of the database servers.

### TECHNICAL FIELD

The present disclosure relates generally to computer networks, Storage Attached Networks (SANs), and, more particularly, to a cluster of computer nodes that are coupled to a sharable data storage system and that involve the distribution of write commands and read commands to the shared storage system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

The task of scaling a software application may involve the distribution of the software application across discrete servers such that each server handles a portion of the workload associated with the application. As the application load of each of the servers increases, additional discrete servers can be added to the network and the workload of the application can be distributed across these additional servers. Some database applications, however, cannot be distributed across discrete servers and do not accommodate the addition of servers to the computer network. In this example, each separate instance of the database application cannot access the entire data set of the storage network of the computer network. The individual database instances are not managed in a manner that permits each database instance to access the entire data set of the storage network. In addition, because each server cannot access the entire data set of the storage network, the computer network cannot accommodate additional servers, as any additional servers would likewise be unable to access the entire data set of the storage network.

### SUMMARY

In accordance with the present disclosure, a system and method is disclosed for managing the serving of read and write commands in a computer cluster system having sharable storage. A plurality of database servers is included in the computer cluster network to serve read and write commands from the database clients of the network. One of the database servers is configured to handle both read commands and write commands. The remainder of the database servers are configured to handle only read commands. The database of the computer system includes a sharable storage subsystem accessible by all database servers that involves the use of mirrored disk elements, with each mirrored disk element being associated uniquely with one of the database servers. When a write is made to the mirrored disk element associated with the write database server, the write command is propagated in the storage subsystem to each of the other storage elements to mirror the write to the disk element associated with the write database server.

The system and method disclosed herein is technically advantageous because is provides a system that efficiently manages the read and write commands of the computer network. All of the write commands are handled by a write server. The numerous read commands of the data base clients are distributed on a workload basis among all of the servers of the database. In this manner, the data access commands of the database clients of the computer network can be distributed among the servers in a manner that shares the workload of the data access commands of the database clients.

Another technical advantage of the system and method disclosed herein is that the redundant storage network of the computer network employs RAID storage techniques to create sets of mirrored disk. A RAID 1 or RAID 1/0 storage methodology can be employed to establish mirrored set of individual drives or groups of drives. The drives can be split out into mirrored logical units. A write to the logical unit associated with the write database server is propagated to each of the other logical units of the redundant storage network.

Another technical advantage of the system and method disclosed herein is the architecture of the network disclosed herein is easily scalable to accommodate the addition of database servers to the computer network. To accommodate an additional database server, another mirrored version of the stored data is created for the added database server. Thus, despite the redundancy and data management efficiencies of the architecture disclosed herein, the architecture can be easily scaled by the addition of a database server and another mirrored version of the data of the redundant storage network. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a computer network;

FIG. 2 is a diagram of a computer network and a redundant disk subsystem;

FIG. 3 is a flow diagram of a method for handling a write command generated by a database client of the computer network; and

FIG. 4 is a flow diagram of a series of method steps for managing the failure of a drive of the redundant disk subsystem of the computer network.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

The system and method disclosed herein provide for a storage network that can be expanded or scaled in size to accommodate the addition of database servers and storage resources. In the system and method disclosed herein, each server of the computer network can serve read commands from a client of the compute network. Only one server of the computer network, however, will be operable to serve both read commands and write commands from clients of the computer network. As such, a read command may be routed and fulfilled by any server of the computer network, while a write command must be routed to a designated server of the computer network. The server handling the write command propagates the data of the write command so that the data is recorded in multiple, redundant storage locations in the computer network. The storage location of the write command in each redundant location is protected from additional read or write commands until the data of the write command has been propagated through each redundant disk resource of the storage in the computer network.

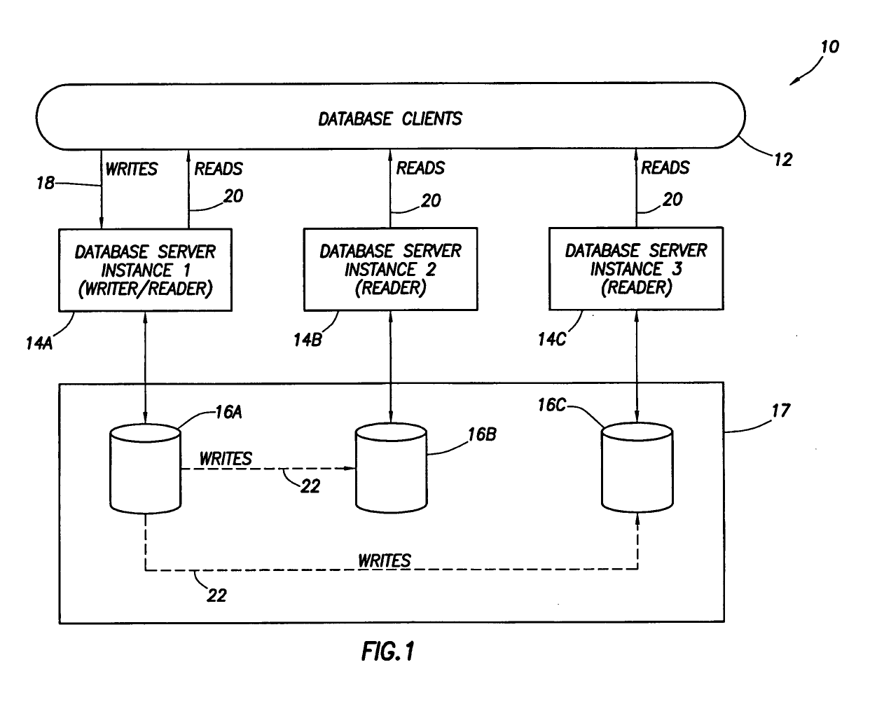

Shown in FIG. 1 is a computer network, which is indicated generally at 10. Computer network 10 includes a set of database clients 12, which are each coupled to the three database servers 14 of the computer network. Each of the database servers 14 includes an instance of database application software. Instance 1 of database software is included in database server 14A; instance 2 of database software is included in database server 14B, and instance 3 of database software is included in database server 14C. Each of database clients includes software for routing write commands and read commands to an appropriate database server 14. In the example of FIG. 1, only database server 14A is designated as handling both write commands 18 and read commands 20. Database server 14A is sometimes referred to herein as a write server because of its ability to handle write commands. Database server 14B and database server 14C are designated as handling only read commands 20 from the clients of the computer network. Thus, all write commands from a database client must be routed by the software of the database clients to database server 14A. Database servers 14B and 14C are sometimes referred to herein as read servers to reflect that each server can only handle read commands. Read commands may be routed by the clients of the computer network to any of the database servers of the computer network.

In the example of FIG. 1, a set of disk resources 16 are coupled to a database server 14. The set of disk resources 16 is included within a storage enclosure 17. Within the storage enclosure 17, the disks 16 are managed by storage management software, including RAID storage management software, that presents the disks to the database servers as one or more logical units. In this example, disk 16A is associated with database server 14A, and receives through database server 14A all of the write commands from the database clients of the computer network. After receiving the data associated with the write command from the clients of the computer network, disk 16A communicates the write to each of disk 16B and disk 16C. Following the communication of the write command to each of the other storage resources of the computer network, each set of storage resources of the computer network has been updated to reflect the changes made by the write request of a client of the computer network. Thereafter, if a client of the network request a read of the data previously written to the storage resources of the computer network by a write command, the data may be accessed through any database server and any set of storage resources 16. Although a read command could be served by any database server of the computer network, read commands may be distributed among the database servers according to the load condition of each server. Because each server is coupled to disk resources that included mirrored content, a read command can be distributed to the server having a lower or the lowest load condition among the database servers of the network. An arbitrator can be included with each database client to distribute write commands to the write database server and to distribute read commands according to the load conditions of the database servers.

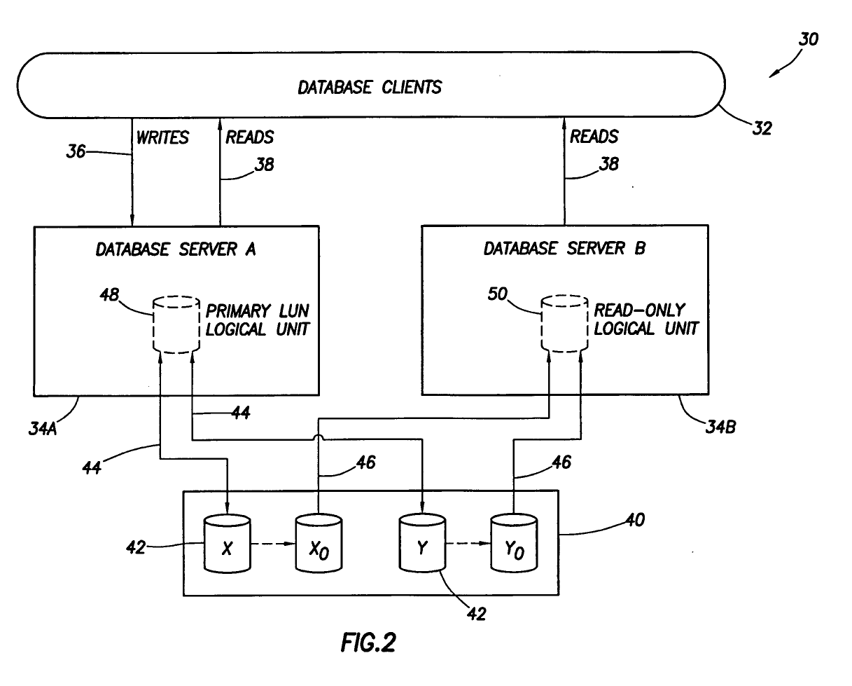

Shown in FIG. 2 is an example of a computer network 30 that includes a shared, redundant disk subsystem 40. A set of database clients 32 are coupled to and transmit read commands and write commands to database server A, which is indicated at 34A, and database server B, which is indicated at 34B. Database clients 32 route all write commands 36 through database server 34A, which is the write database of the computer network. Database clients 32 route read commands through either database server 34A or database server 34B. Database server 34B is the read database of the computer network. Each of database server 34A and database server 34B is coupled to redundant storage system 40. Redundant storage network 40 may comprise a RAID implementation. In the example of FIG. 2, storage network 40 includes a RAID 1/0 implementation. A RAID 1/0 configuration involves the mirroring of individual drives 42, followed by the striping of each set of mirrored drives. Within storage network 40, drive X is mirrored at Drive X₀, and Drive Y is mirrored at drive Y₀. The combination of the mirrored set of X-X₀ and the mirrored set of Y-Y₀ comprise a single stripe of drives.

The individual drives of the storage network 40 can be organized into logical units. A logical unit is an abstraction of a physical disk or a set of physical disks that are presented to a server or group of servers as a single disk capable of storing data Logical units are accessible through a target device, which is the storage system that provides the abstraction of the physical disks to logical units. In the example of FIG. 2, the set of drives X and Y comprise a single logical unit 48 that is accessible only through database server 34A. The set of drives X₀ and Y₀ comprise a second logical unit 50 that is only accessible through database server 34B. Logical unit 48 is described herein as a primary logical unit or write-possible logical unit and is able to be accessed for both read commands and write commands. Logical unit 50 is described herein as a read-only logical unit and is able to be accessed for read commands only. As such, drives X and Y, which are associated with the logical unit 48 of database server 34, are able to be accessed for read commands and write command. Drive X₀ and Y₀, which are associated with the logical unit 50 of database server 34B, are accessible for read commands only.

In operation, if a write command from one of the database clients 32, the write command is transmitted to a target logical unit in the storage system through database server 34A, which is the write server of the computer network and is associated with the drives of the primary logical unit 48 of the computer network. Database server directs the write command, depending on the address of the write command to drive X or drive Y. Assuming that the write command is directed to an address on drive X, the write command is executed with respect to drive X, with the result being the write of the data of the write command to target address in drive X. Following the write to drive X, the RAID storage system of storage network 40 propagates the write command to the X₀ drive according to the RAID 1/0 storage scheme. Following this propagation step, the data written to the X drive of primary logical unit 48 has been transmitted to drive X₀ of read-only logical unit 50. Following the write command, the data written to storage as a result of the write command can be accessed through a read command served by database server 34A to a storage drive within primary logical unit 48 or through a read command served by read-only database server 34B to a storage drive within read-only logical unit 50. Each of the logical units of the computer network includes a copy of the data of the computer network.

Shown in FIG. 3 is a series of method steps for handling a write command generated by a database client of the computer network. At step 60, a database client of the computer network initiates a write command. At step 62, the write command is routed to the write server, which is the database server associated with the primary logical unit. The write database server and the primary logical unit are configured as the only database server and the only logical unit within the computer network that are operable to handle write commands from a client of the computer network. At step 64, the data of the write command is saved to the addressed disk location in the primary logical unit. At step 66, all read commands directed to a read-only logical unit at the address of the write command to the primary logical unit are disabled. As a result of step 66, a client cannot read from a disk location in a read-only logical unit that is in the process of being written to the primary logical unit. The disabling of these reads commands allows the write command to be performed atomically such that, once a write is initiated, all reads to corresponding memory locations in mirrored disks are suspended until each of the mirrored disk locations are updated with the content of the write command. Step 68 concerns the step of updating the associated disk locations of each of the read-only logical units with the content of the write command directed to the primary logical unit. The step of mirroring the content of the primary logical unit to the read-only logical unit is accomplished by the RAID implementation within the storage system. At step 70, following the propagation of the content of the write command to each corresponding storage location in the storage network, read commands directed to the corresponding disk location of the write commands are enabled in the read-only logical units.

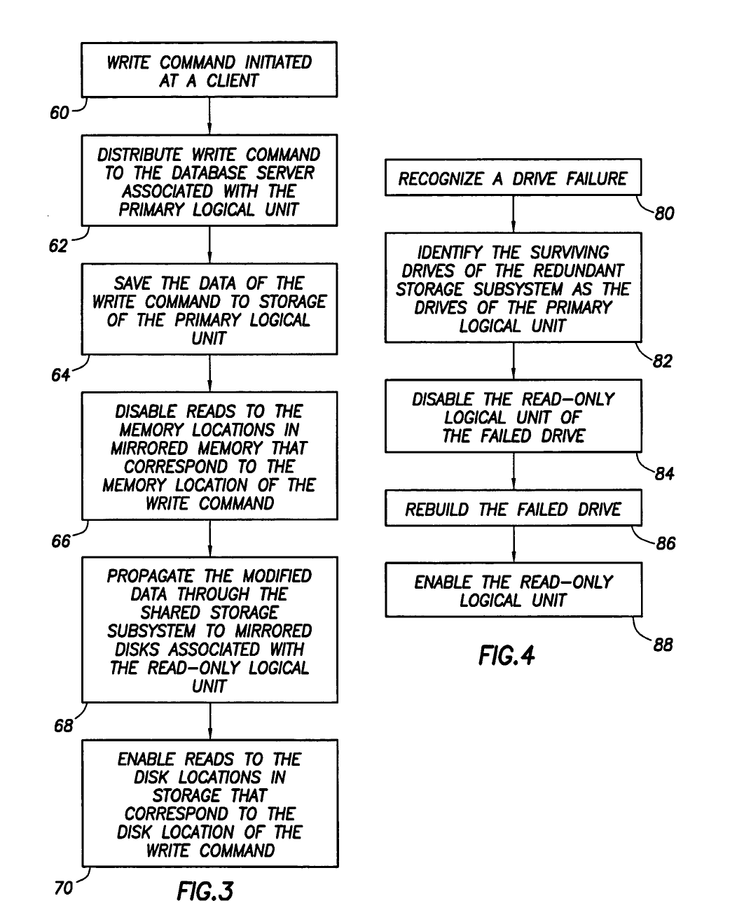

The system and method disclosed herein may accommodate drive failures within the redundant disks of the storage subsystem of the network. Shown in FIG. 4 are a series of method steps for managing the failure of a drive of the redundant storage subsystem of the network. The steps of FIG. 4 will be described herein with reference to FIG. 2, which discloses a recovery methodology in a RAID 1/0 disk subsystem in which drives X and X₀ form a first mirrored combination and drives Y and Y₀ form a second mirrored drive combination. The primary logical unit is comprised of drives X and Y, and the read-only logical unit in this example is comprised of drives X₀ and Y₀. At step 80, a drive of the storage subsystem is recognized has having failed. In this example, the failed drive may be drive X.

At step 82, a surviving set of drives of a logical unit of the storage subsystem is identified and designated as the drives of the primary logical unit. In the present example, the surviving logical unit is the read-only logical unit of drives X₀ and Y₀. As a result, drives X₀ and Y₀ are designated as the drives of the primary logical unit of the computer network. All write command continued to be processed through the write database server. The logical unit of the write database server has been modified so that the logical unit is now drives X₀ and Y₀ instead of drives X and Y. At step 84, the read-only logical unit of the failed drive is disabled and the failed drive is rebuilt. In this example, the rebuild of drive X occurs with the data of mirrored drive X₀. Following the rebuild of the failed drive, the logical unit of the failed drive is enabled at step 86. At this point, the drives of the redesignated primary logical unit (X₀ and Y₀) may be returned to their status as drive of a read-only logical unit. Alternatively, the drives of the redesignated primary logical unit need not be redesignated, as a primary logical unit (X₀ and Y₀) and a mirrored logical unit (X and Y) are in place in the computer network.

Although the RAID subsystem of the present disclosure has been described as having a RAID 1/0 storage methodology, it should be recognized that other RAID configuration that involve the use of mirrored volumes may be employed. One example is a RAID 1 configuration, which involves the one-to-one mirroring of each drive of the RAID array. The system and method disclosed herein also provides for a redundant network that is easily scalable. An additional database server can be added for each mirrored storage element in the storage subsystem. For example, with respect to a RAID 1 array, if a writeable drive is mirrored across two additional drives, then two additional database servers can be added to the computer network, with each additional database server having access to a mirrored version of the content of the memory subsystem. Although the present disclosure has been described in detail, it should be understood that various changes, substitutions, and alterations can be made hereto without departing from the spirit and the scope of the invention as defmed by the appended claims.

What is claimed is:

1. A computer network, comprising:
a plurality of database servers, wherein one database server of the set of database servers is designated as being operable to serve write command and wherein each database server of the set of database servers is operable to serve read commands;
a shared redundant storage network coupled to the database servers, wherein the redundant storage network includes a plurality of mirrored sets of the storage data of the storage network, and wherein each set of storage data is associated with one of the database servers;
wherein the set of storage data associated with the database server that is designated to serve write command is operable to propagate to the other sets of storage data the data of any write commands served by the database server designated to serve write commands.

2. The computer network of claim 1, wherein the shared redundant storage network comprises RAID storage.

3. The computer network of claim 1, wherein the shared redundant storage network comprises RAID 1/0 storage.

4. A computer network, comprising:
a plurality of clients;
a first server coupled to the plurality of clients;
a second server coupled to the plurality of clients, wherein only the first server designated as being operable to server write commands from any of the clients and wherein each of the first server and the second server is designated as being operable to serve read commands from any one of the clients; and
a storage network coupled to the plurality of servers, wherein the storage network includes a first logical unit coupled to the first server and a second logical unit coupled to the second server, and wherein the data of write commands stored in the first logical unit are propagated to the second logical unit.

5. The computer network of claim 4, wherein the storage elements of the first logical unit and the storage elements of the second logical unit are collectively organized to store data according to a RAID storage methodology.

6. The computer network of claim 4, wherein the storage elements of the first logical unit and the storage elements of the second logical unit are collectively organized to store data according to a RAID 1/0 storage methodology in which the data content of a first drive of the first logical unit is a duplicate of the data content of the first drive of the second logical unit, and the data content of a second drive of the first logical unit is a duplicate of the data content of the second drive of the second logical unit.

7. The computer network of claim 4, wherein the storage elements of the first logical unit and the storage elements of the second logical unit are collectively organized to store data according to a RAID 1 storage methodology in which each drive of the first logical unit is mirrored in a corresponding drive of the second logical unit.

8. The computer network of claim 4, further comprising an arbiter associated with the clients of the computer network for distributing writes to the first server of the computer network and for distributing read command to the first server or the second server of the computer system on the basis of the relative load conditions of the servers.

9. A method for managing read and write commands in a computer network having a set of database servers coupled to common storage, comprising:
providing a first database server within the set of database servers, wherein the first database server is operable to handle read commands and is the only database server among the set of database servers that is operable to serve write commands;
providing one or more read-only database servers within the set of database servers, wherein each of the read-only database server is not operable to handle write commands and is operable to handle read commands;
providing a plurality of logical units, wherein each one of the logical units is uniquely associated with one of the database servers of the set of database servers;
distributing a write command to the first database server;
saving the data of the write command to the logical unit that is associated with the first database server;
propagating the data of the write command from the logical unit associated with the first database server to each other logical units.

10. The method for managing read and write commands in a computer network of claim 9, wherein the plurality of logical units comprise a redundant storage methodology that is operable to save data according to a RAID storage methodology.

11. The method for managing read and write commands in a computer network of claim 9, wherein the plurality of logical units comprise a redundant storage methodology that is operable to save data according to a RAID methodology in which the content of each logical unit is a duplicate of each other logical unit in the plurality of logical units.

12. The method for managing read and write commands in a computer network of claim 9,
wherein the first database server is coupled to a first logical unit within the plurality of logical units;
wherein each of the other database servers is coupled to a unique logical unit within the plurality of logical units; and
wherein the content of the first logical unit is mirrored across the logical units coupled to each of the other database servers of the computer network.

13. The method for managing read and write commands in a computer network of claim 9,
wherein the first database server is coupled to a first logical unit within the plurality of logical units, and wherein the first logical unit includes a plurality of drives;
wherein each of the other database servers is coupled to a unique logical unit within the plurality of logical units, and wherein each unique logical unit includes a plurality of drives that are respectively identical to each of the drives of the first logical unit.

14. The method for managing read and write commands in a computer network of claim 9, further comprising the steps of:
disabling the ability to read from logical units not associated with the first database server following the initiation of a write to the logical unit associated with the first database server; and
enabling the ability to read from the logical units not associated with the first database server following the propagation of the data of the write command to each of the logical units not associated with the first database server.

15. The method for managing read and write commands in a computer network of claim 12, further comprising the steps of:
identifying the failure of a drive of a logical unit;
identifying a logical unit that includes a complete set of drives;
designating a logical unit that includes a complete set of drive as the logical unit associated with the first database server; and
disabling the ability of the database servers other than the first database server to serve read commands.

16. The method for managing read and write commands in a computer network of claim 15, further comprising the steps of:
rebuilding the failed drive of the logical unit; and
enabling the ability of the database servers other than the first database server to serve read commands.

17. A computer network, comprising:
a plurality of database clients;
a plurality of database servers, wherein each database client is operable to transmit commands to each of the database servers, wherein the plurality of database servers includes one write database server, and wherein only the write database server is operable serve write commands to the database clients; and
a database coupled to the database servers, wherein the database includes a plurality of mirrored storage elements, wherein each storage element is uniquely associated with one of the database servers, and wherein a write stored in the storage element associated with the write database server is propagated to each of the other storage elements of the database.

18. The computer network of claim 17, further comprising an arbiter associated with the database clients, wherein the arbiter is operable to transmit all write commands from the database clients to the write database server and is operable to transmit all read commands to one of the plurality of database servers on the basis of the load of the database servers.

19. The computer network of claim 17, wherein the mirrored storage elements store data according to a RAID storage methodology.

20. The computer network of claim 17, wherein the mirrored storage elements store data according to a RAID 1/0 storage methodology in which the drives of the storage element associated with the write database server are mirrored in each of the drives of the other storage elements of the database.
